(19) United States
(12) Patent Application Publication
(10) Pub. No.: US 2019/0377104 A1
(43) Pub. Date: Dec. 12, 2019

(54) LENS AND LENS MANUFACTURING METHOD

(71) Applicant: Nidec Corporation, Kyoto (JP)

(72) Inventors: Muneyuki OTANI, Kyoto (JP); Takashi NAKAYAMA, Kyoto (JP); Takanori KAMOTO, Kyoto (JP)

(21) Appl. No.: 16/486,172

(22) PCT Filed: Feb. 16, 2018
(86) PCT No.: PCT/JP2018/005586

§ 371 Date: Aug. 15, 2019

(30) Foreign Application Priority Data
Mar. 1, 2017 (JP) 2017-038286

(51) Int. Cl. G02B 1/113; G02B 1/04; G02B 1/14; G02B 3/00

(52) U.S. Cl. CPC G02B 1/113; G02B 1/041; G02B 2003/0093; G02B 3/00; G02B 1/14

(57) ABSTRACT

A lens includes a lens body that is made of resin and that includes a convex surface, a buffer layer arranged on the convex surface, and an antireflection layer arranged on the buffer layer. The buffer layer has a thickness of about 0.7 μm or more and about 6.1 μm or less, and the antireflection layer has a thickness of about 0.07 μm or more and about 0.57 μm or less. In a more preferable lens, the buffer layer has a thickness of about 1.0 μm or more and about 5.0 μm or less, and the antireflection layer has a thickness of about 0.10 μm or more and about 0.50 μm or less.

### CROSS REFERENCE TO RELATED APPLICATION

This is the U.S. national stage of PCT Application No. PCT/JP2018/005586, filed on Feb. 16, 2018, and priority under 35 U.S.C. § 119(a) and 35 U.S.C. § 365(b) is claimed from Japanese Application No. 2017-038286, filed Mar. 1, 2017; the entire disclosures of each application being hereby incorporated herein by reference.

### 1. FIELD OF THE INVENTION

The present disclosure relates to a lens and a lens manufacturing method.

### 2. BACKGROUND

In the related art, an antireflection layer is arranged on the surface of an optical lens formed of glass. An antireflection layer is formed on a lens body by employing vapor deposition, for example, to coat the lens body with an inorganic substance. Both the lens body and the antireflection layer are formed of inorganic substances and thus closely adhere to each other. In addition, both the lens body and the antireflection layer are close in terms of physical properties such as the linear expansion coefficient and thus are less prone to failures such as cracking and peeling even if temperature variations or humidity variations occur.

In recent years, there have been attempts to form lens bodies with resin to achieve reduced weight and cost. For example, a conventional lens body includes a lens body formed of an optical resin material. An optical functional film including an antireflection film is formed on the surface of the lens body.

When an antireflection layer is arranged directly on the surface of a lens body made of resin, cracking or other failures occur in the antireflection layer in, for example, a high-temperature environment due to the difference in linear expansion coefficient between the lens body and the antireflection layer. It is thus considered that a buffer layer, which is an intermediate layer, be arranged between the lens body and the antireflection layer to prevent, for example, cracking of the antireflection layer.

On the other hand, for example, when a lens including an antireflection layer and a buffer layer is arranged on the outermost side of a lens unit, the lens is required to have high heat resistance and scratch resistance. However, it is not easy for such a lens including an antireflection layer and a buffer layer to have predetermined lens performance with the heat resistance and the scratch resistance improved.

Example embodiments of the present disclosure enable lenses each including an antireflection layer and a buffer layer to achieve predetermined lens performance and improve heat resistance and scratch resistance.

### SUMMARY

A lens according to an example embodiment of the present disclosure includes a lens body that is made of resin and that includes a convex surface, a buffer layer arranged on the convex surface, and an antireflection layer arranged on the buffer layer. The buffer layer has a thickness of about 0.7 μm or more and about 6.1 μm or less, and the antireflection layer has a thickness of about 0.07 μm or more and about 0.57 μm or less.

A lens manufacturing method according to an example embodiment of the present disclosure includes a step a) of forming a buffer layer having a thickness of about 0.7 μm or more and about 6.1 μm or less on a convex surface of a lens body made of resin, and a step b) of forming an antireflection layer having a thickness of about 0.07 μm or more and about 0.57 μm or less on the buffer layer.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view illustrating a configuration of a lens.

FIG. 2 is a flowchart illustrating the manufacture of the lens.

FIG. 3 illustrates the formation of a buffer layer.

FIG. 4 illustrates the thicknesses of the buffer layers and antireflection layers and the evaluation results of various kinds of performance.

FIG. 5 illustrates the relationship between the thicknesses of the buffer layers and the antireflection layers and overall rating results.

### DETAILED DESCRIPTION

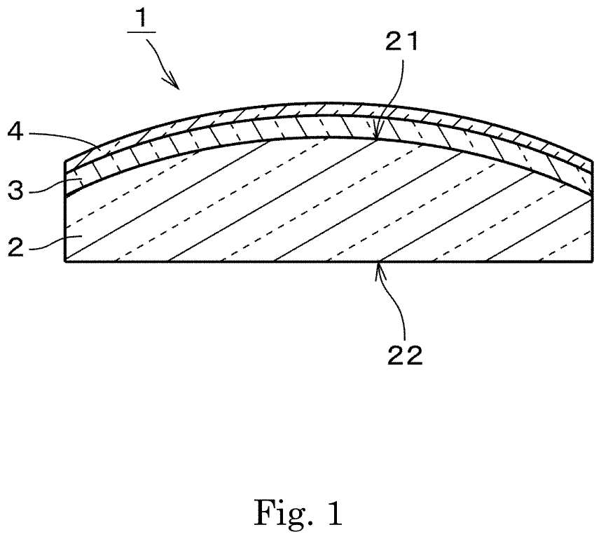

FIG. 1 is a sectional view illustrating a configuration of a lens 1 according to an exemplary example embodiment of the present disclosure. The lens 1 is, for example, a lens that is arranged on the outermost side of a lens unit arranged in an automotive imaging device, that is, on the side closest to an object.

The lens 1 includes a lens body 2, a buffer layer 3, and an antireflection layer 4. The lens body 2 is made of resin. The lens body 2 is, for example, composed only of resin. Various resins are usable for forming the lens body 2. For example, acrylic resin, amorphous polyolefin resin, and polycarbonate resin are usable for forming the lens body 2.

The thickness of the lens body 2 on the optical axis of the lens 1 is, for example, about 0.3 mm (millimeters) or more, preferably about 1.5 mm or more. In the example in FIG. 1, the lens body 2 has a thickness of about 2.96 mm. In consideration of ordinary uses of a lens made of resin, the lens body 2 has a thickness of, for example, about 30 mm or less. The lens body 2 has a thickness of preferably about 10 mm or less, more preferably about 5.0 mm or less. The lens body 2 has a diameter of, for example, about 3.0 mm or more, preferably about 7.0 mm or more. In the description, the diameter of the lens body 2 is the diameter of a region of the lens body 2 that functions as a lens. In the example in FIG. 1, the lens body 2 has a diameter of about 11.6 mm. In consideration of ordinary uses of a lens made of resin, the lens body 2 has a diameter of, for example, about 100 mm or less. The lens body 2 has a diameter of preferably about 50 mm or less, more preferably about 20 mm or less.

The lens body 2 includes two lens surfaces 21 and 22. One lens surface of the lens body 2, that is, the lens surface 21 is a surface arranged on the object side and is a convex surface. The lens surface 21 is, for example, a spherical surface. The lens surface 21 has a curvature radius of, for example, about 8 mm or more, preferably about 10 mm or more. In the example in FIG. 1, the lens surface 21 has a curvature radius of about 13.8 mm. When the lens 1 is used as the outermost lens in the imaging device, the lens surface 21, which is a convex surface, has a curvature radius of, for example, about 10 mm or more, preferably 12 mm or more. The other lens surface of the lens body 2, that is, the lens surface 22 is a surface arranged on the image side and is a flat surface in FIG. 1. The lens surface 22 may be a convex surface or a concave surface.

The buffer layer 3 is arranged on the lens surface 21. Preferably, the buffer layer 3 is arranged directly on the lens surface 21. That is, the buffer layer 3 is in contact with the lens surface 21. The buffer layer 3 is, for example, made of resin containing inorganic particles and is a transparent thin film. The inorganic particles are dispersed in the resin layer in the buffer layer 3. The use of resin containing an inorganic substance for forming the buffer layer 3 enables the film to achieve high hardness and high scratch resistance. For example, acrylic resin and amorphous polyolefin resin are usable as the resin. In addition, the inorganic particles contain particles of metal oxides such as amorphous silica and alumina. The inorganic particles may contain particles other than metal oxides. The buffer layer 3 has a thickness of preferably about 0.7 μm (micrometers) or more and about 6.1 μm or less, more preferably about 1.0 μm or more and about 5.0 μm or less. The reason why the above thickness range of the buffer layer 3 is preferable will be described below. The thickness of the buffer layer 3 can be measured by using, for example, an optical coating thickness gauge. The thickness of the antireflection layer 4 can also be measured in such a manner. The hardness of the buffer layer 3 is preferably higher than that of the lens body 2.

The antireflection layer 4 is arranged on the buffer layer 3. Preferably, the antireflection layer 4 is arranged directly on the buffer layer 3. That is, the antireflection layer 4 is in contact with the buffer layer 3. The antireflection layer 4 is, for example, made of an inorganic oxide and is a transparent thin film. For example, metal oxides such as silicon oxide, titanium oxide, lanthanum titanate, tantalum oxide, and niobium oxide are usable as the inorganic oxide. Preferably, plural kinds of metal oxide layers are layered in the antireflection layer 4. The antireflection layer 4 has a thickness of preferably about 0.07 μm or more and about 0.57 μm or less, more preferably about 0.10 μm or more and about 0.50 μm or less. The thickness of the antireflection layer 4 is less than that of the buffer layer 3. The reason why the above thickness range of the antireflection layer 4 is preferable will be described below.

The buffer layer 3 arranged between the lens body 2 and the antireflection layer 4 enables adhesion of the antireflection layer 4 to the lens 1 to be improved. The buffer layer 3 has a linear expansion coefficient between the linear expansion coefficient of the lens body 2 and the linear expansion coefficient of the antireflection layer 4. The buffer layer 3 reduces the stress applied to the antireflection layer 4 due to the difference in linear expansion coefficient between the lens body 2 and the antireflection layer 4. As a result, a crack due to temperature variations is prevented from occurring in the antireflection layer 4. In the description, “crack” in the antireflection layer refers to damage such as a fine crack and fine peeling occurring in the antireflection layer. A water-repellent layer or other functional layers may be arranged on the antireflection layer 4. In addition, such functional layers may be arranged on the other lens surface of the lens body 2, that is, the lens surface 22.

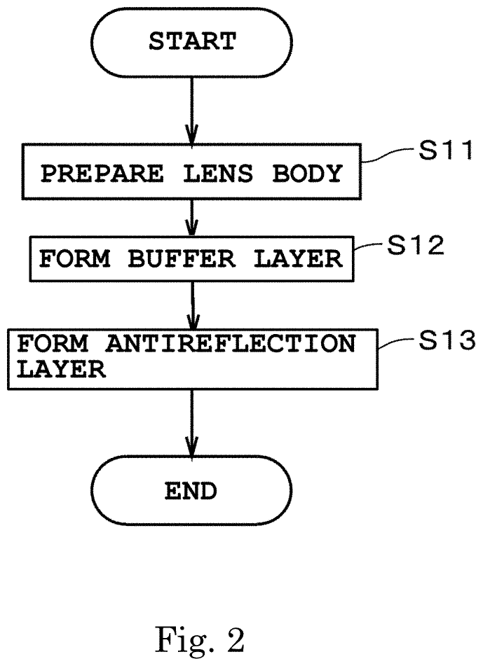

Subsequently, the manufacture of the lens 1 will be described with reference to FIG. 2. In the manufacture of the lens 1, first, the lens body 2 is prepared (step S11). The lens body 2 is, for example, formed of lens-body-forming material by injection molding. The lens-body-forming material contains, for example, the resins cited as examples of the materials of the lens body 2. The resins have thermoplasticity. After the lens body 2 is prepared, the buffer layer 3 is formed on one lens surface, that is, the lens surface 21 of the lens body 2 (step S12).

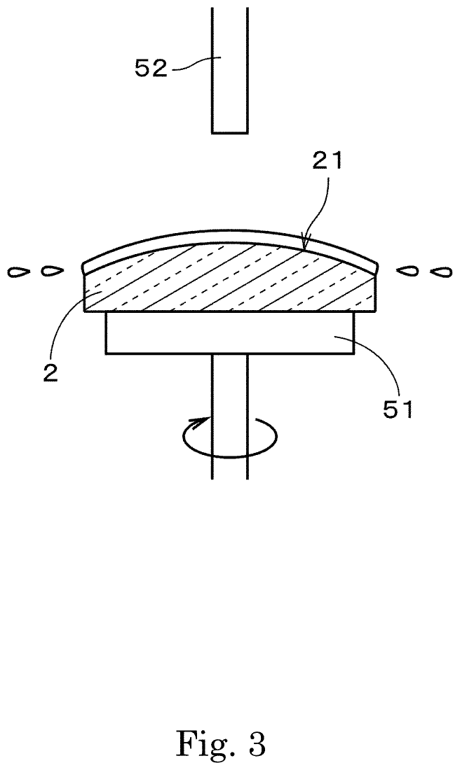

FIG. 3 illustrates the formation of the buffer layer 3. In the formation of the buffer layer 3, first, the lens body 2 is placed on a rotating holder 51 in a coating device. The rotating holder 51 is rotatable about a shaft by using a motor (not illustrated). In the process example, the lens body 2 is held by the rotating holder 51 with the lens surface 21, which is a convex surface, facing upward. The lens surface 21 is referred to as “object lens surface 21” in the description below.

Subsequently, a predetermined amount of buffer-layer-forming material drops onto the object lens surface 21 from a nozzle 52 arranged above the rotating holder 51. The buffer-layer-forming material is liquid containing inorganic particles and resin. The buffer-layer-forming material contains, for example, the inorganic particles and the resins, which are cited as examples of the materials of the buffer layer 3. In the process example, the buffer-layer-forming material is ultraviolet curable. The buffer-layer-forming material may have a thermosetting property. An example of the buffer-layer-forming material is a liquid in which amorphous silica, acrylic resin, a photopolymerization initiator, and a solvent that is predominantly composed of propylene glycol monomethyl ether (PGM) are mixed in a desired ratio.

In the coating device, an excess buffer-layer-forming material is removed from the object lens surface 21 by the rotating holder 51 rotating the lens body 2 at a predetermined rotation rate, that is, by spin coating. In this manner, the buffer-layer-forming material is applied onto the object lens surface 21 to form a film of the buffer-layer-forming material. Subsequently, the film is cured by irradiating the film with a predetermined amount of ultraviolet radiation. The buffer layer 3 is formed on the object lens surface 21 by the above process. The buffer-layer-forming material may be applied onto the object lens surface 21 by immersing the object lens surface 21 in the buffer-layer-forming material stored in a container, that is, by dipping.

After the buffer layer 3 is formed, the antireflection layer 4 is formed on the buffer layer 3 (step S13). In the formation of the antireflection layer 4, for example, a film of antireflection-layer-forming material is formed on the buffer layer 3 by vapor deposition. A preferable example of the vapor deposition is ion-assisted deposition. A film having high adhesion and high density is formed by ion-assisted deposition. The antireflection layer 4 may be formed by sputtering, for example. The antireflection-layer-forming material contains, for example, the inorganic oxides cited as examples of the materials of antireflection layer 4. An example of the antireflection layer 4 is a multilayer film in which thin films of silicon oxide and titanium oxide are alternately layered. The multilayer film is, for example, a set of five or seven thin films. The lens 1 is manufactured by the above process.

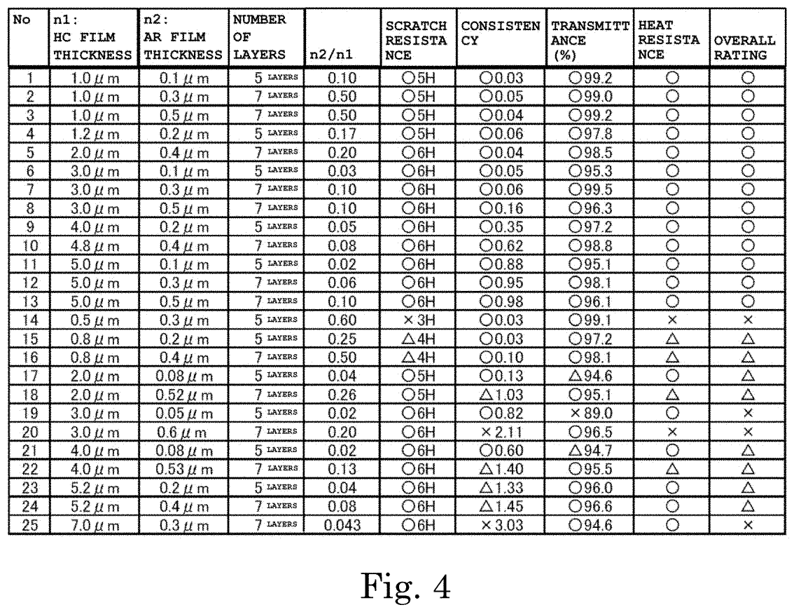

FIG. 4 illustrates the thicknesses of the buffer layers 3 and the antireflection layers 4 in the lenses and the evaluation results of various kinds of performance. In the description, the thicknesses of the buffer layers 3 vary in accordance with various conditions for forming the buffer layer 3 in step S12 in FIG. 2. The buffer layer 3 required to have scratch resistance is referred to also as a hard coat layer, and thus “HC Film Thickness” denotes the thicknesses of the buffer layers 3 in FIG. 4. In a similar manner, the thicknesses and the number of the antireflection layers vary in accordance with various conditions for forming the antireflection layer 4 in step S13. In FIG. 4, “AR Film Thickness” denotes the thicknesses of the antireflection layers 4, and “Number of Layers” denotes the number of the antireflection layers 4. Each thickness of the antireflection layers 4 is a whole thickness of a multilayer film that functions as the antireflection layer 4. The thicknesses of the buffer layers 3 and the antireflection layers 4 were each measured at the center of the lens body 2 by using an optical coating thickness gauge. In addition, the ratio between the thickness of the buffer layer 3 and the thickness of the antireflection layer 4 is defined as (n2/n1), where n1 is the thickness of the buffer layer 3 and n2 is the thickness of the antireflection layer 4.

A contact surface profiler was used to evaluate consistency. Specifically, the surface profile of the object lens surface 21 was measured before step S12, and the surface profile of the antireflection layer 4 was measured after step S13. Subsequently, the height differences between the corresponding positions in the measured surface profiles that overlap each other were calculated. The difference between the maximum value and the minimum value of the height differences in all the corresponding positions was then calculated as a PV value, and the PV value was defined as an index of the consistency in each lens. In FIG. 4, the lenses having a PV value of about 1 μm or less are denoted by “O”, the lenses having a PV value of more than about 1 μm and about 2 μm or less are denoted by “Δ”, and the lenses having a PV value of more than about 2 μm are denoted by “X”.

To evaluate scratch resistance, a sheet made of resin similar to the lens body 2 was subjected to the processes in steps S12 and S13 to prepare a test piece in which the buffer layer 3 and the antireflection layer 4 are arranged on the sheet. A pencil hardness test was then performed on the test piece. In the pencil hardness test, whether there was a scratch on the test piece was inspected by moving a pencil lead with the pencil lead pressed against the test piece under a predetermined load. The operation was repeated with the hardness of the pencil lead changed in turn, and the hardness of the hardest one of the pencils lead by which no scratch was left on the test piece was defined as the evaluation result of the scratch resistance of each lens. In FIG. 4, the lenses whose evaluation results of 5H or harder are denoted by “O”, the lenses whose evaluation results of 4H are denoted by “Δ”, and the lens whose evaluation result of 3H or softer is denoted by “x”. The scratch resistance can be considered as wear resistance. The scratch resistance may be evaluated by other techniques. For example, a technique in which a brush is moved a predetermined number of times with the brush pressed against a lens under a fixed load and whether there is a scratch on the lens is checked is usable for the evaluation.

To evaluate transmittance, the lens transmittance to light in a visible wavelength range, that is, about 380 nm (nanometers) to about 780 nm was measured. In FIG. 4, the lenses having a transmittance of about 95% or more are denoted by “O”, the lenses having a transmittance of less than about 95% and about 90% or more are denoted by “Δ”, and the lens having a transmittance of less than about 90% is denoted by “X”.

To evaluate heat resistance, each lens was left in an atmosphere at about 105° C. for about 500 hours and about 1000 hours, and then whether there was a crack in the antireflection layer 4 or a deformation in the lens was checked by using a microscope. In FIG. 4, the lenses in which no crack or no deformation occurred after the lenses had been left for about 1000 hours are denoted by “O”, the lenses in which a crack or a deformation occurred after the lenses had been left for about 1000 hours but in which no crack or no deformation occurred after the lenses had been left for about 500 hours are denoted by “Δ”, and the lenses in which a crack or a deformation occurred after the lenses had been left for about 500 hours are denoted by “X”.

In addition, in “Overall Rating” in FIG. 4, the lenses for which all evaluation results, which are the scratch resistance, the consistency, the transmittance, and the heat resistance, are denoted by “O” are denoted by “O”, the lenses for which at least one of the evaluation results is denoted by “X” are denoted by “x”, and the other lenses are denoted by “Δ”.

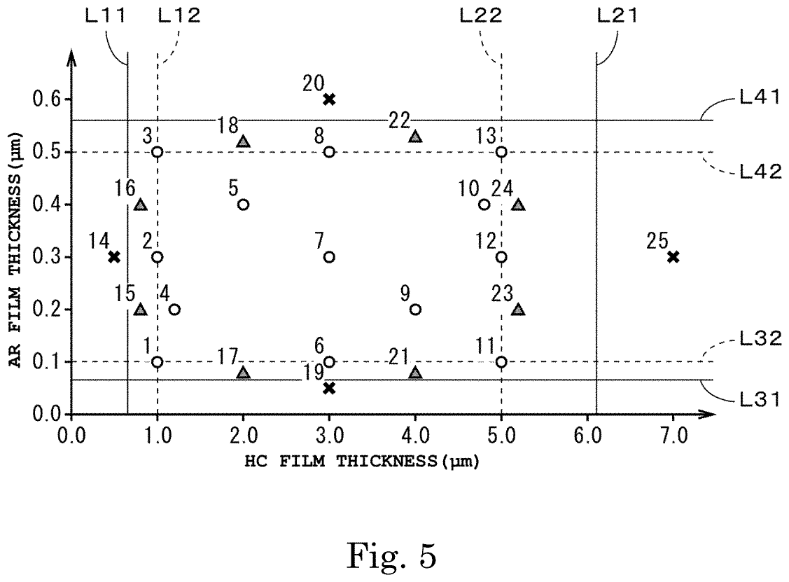

FIG. 5 illustrates the relationship between the thicknesses of the buffer layers 3 and the antireflection layers and overall rating results. In FIG. 5, the horizontal axis indicates the thickness of the buffer layer 3, and the vertical axis indicates the thickness of the antireflection layer 4. In FIG. 5, Lens Nos. 1 to 25 in FIG. 4 each assigned one of the symbols, “O”, “Δ”, or “X”, which indicates the overall rating result, alongside the corresponding lens number are plotted at the positions according to the thicknesses of the buffer layers 3 and the antireflection layers 4.

In FIG. 4, it is clear from the evaluation results of Lens Nos. 14 to 16 and Nos. 1 to 5 that the scratch resistance and the heat resistance are improved as the thickness of the buffer layer 3 increases. Specifically, when the buffer layer 3 has a thickness of about 0.7 μm or more, it can be said that certain degrees of scratch resistance and heat resistance are achieved (see line L11 in FIG. 5). In addition, when the buffer layer 3 has a thickness of about 0.8 μm or more, the scratch resistance and the heat resistance can be more reliably improved, and when the buffer layer 3 has a thickness of about 1.0 μm or more, the scratch resistance and the heat resistance can be sufficiently improved (see line L12 in FIG. 5). The buffer layer 3 has a thickness of preferably about 1.6 μm or more to further improve the scratch resistance. On the other hand, when the buffer layer 3 has a thickness of less than about 0.7 μm, the buffer layer 3 has low scratch resistance and thus may not function as a hard coat layer, and in the evaluation of the heat resistance, a crack occurred in the antireflection layer 4.

In FIG. 4, it is clear from the evaluation results of Lens Nos. 9 to 13 and Nos. 23 to 25 that the PV value increases, that is, the consistency deteriorates as the thickness of the buffer layer 3 increases. The PV value is affected by deformation of a lens shape, and thus the PV value is preferably small in order that a lens can have predetermined lens performance. Specifically, when the buffer layer 3 has a thickness of about 6.1 μm or less, it can be said that a certain degree of lens performance is achieved (see line L21 in FIG. 5). In addition, when the buffer layer 3 has a thickness of about 5.2 μm or less, the PV value can be more reliably reduced, and when the buffer layer 3 has a thickness of about 5.0 μm or less, the PV value can be sufficiently reduced (see line L22 in FIG. 5). The buffer layer 3 has a thickness of preferably about 4.4 μm or less to further improve the lens performance. On the other hand, when the buffer layer 3 has a thickness of more than about 6.1 μm, the buffer layer 3 has low consistency and thus may not achieve predetermined lens performance due to deformation of the lens shape, for example.

It is clear from the evaluation results of Lens Nos. 19, 17, 21, 6, and 9 that the transmittance increases as the thickness of the antireflection layer 4 increases. Specifically, when the antireflection layer 4 has a thickness of about 0.07 μm or more, it can be said that a certain degree of transmittance is achieved, and thus the antireflection layer 4 has a satisfactory function of antireflection (see line L31 in FIG. 5). In addition, when the antireflection layer 4 has a thickness of about 0.08 μm or more, the transmittance can be more reliably increased, and when the antireflection layer 4 has a thickness of about 0.10 μm or more, the transmittance can be sufficiently increased (see line L32 in FIG. 5). On the other hand, when the antireflection layer 4 has a thickness of less than about 0.07 μm, the antireflection layer 4 has an unsatisfactory function of antireflection, and ghosts or flares are prone to occur.

It is clear from the evaluation results of Lens Nos. 5, 8, 18, 22, and 20 that the consistency and the heat resistance deteriorate as the thickness of the antireflection layer 4 increases. Specifically, when the antireflection layer 4 has a thickness of about 0.57 μm or less, it can be said that certain degrees of consistency and heat resistance are achieved (see line L41 in FIG. 5). When the antireflection layer 4 has a thickness of about 0.53 μm or less, the consistency and the heat resistance can be more reliably improved, and when the antireflection layer 4 has a thickness of about 0.50 μm or less, the consistency and the heat resistance can be sufficiently improved (see line L42 in FIG. 5). On the other hand, when the antireflection layer 4 has a thickness of more than about 0.57 μm, the antireflection layer 4 has low consistency and thus may not achieve predetermined lens performance due to deformation of the lens shape, for example, and in the evaluation of the heat resistance, deformation such as warpage occurred in the lens.

As described above, in the lens 1, the buffer layer 3 has a thickness of about 0.7 μm or more and about 6.1 μm or less, and the antireflection layer 4 has a thickness of about 0.07 μm or more and about 0.57 μm or less. This configuration enables the lens 1 to have predetermined lens performance with the heat resistance and the scratch resistance improved. In the above numerical ranges, the ratio (n2/n1) between the thickness of the buffer layer 3 and the thickness of the antireflection layer 4 is about 0.01 or more and about 0.81 or less.

The buffer layer 3 has a thickness of preferably about 1.0 μm or more and about 5.0 μm or less. The antireflection layer 4 has a thickness of preferably about 0.10 μm or more and about 0.50 μm or less. This configuration enables the various kinds of performance of the lens 1 to be further improved. In the above numerical ranges, the ratio (n2/n1) between the thickness of the buffer layer 3 and the thickness of the antireflection layer 4 is about 0.02 or more and about 0.50 or less.

The lens 1 and the manufacture of the lens 1 can be variously modified. For example, the lens 1 may be a lens other than the outermost lens of a lens unit. In addition, the lens 1 may have uses other than use in an automotive imaging device.

The present disclosure is applicable to lenses for various uses and, in particular, suitable for a lens which is used or may be used in a high temperature environment.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-8. (canceled)

9: A lens comprising:
a lens body that is made of resin and that includes a convex surface;
a buffer layer arranged on the convex surface; and
an antireflection layer arranged on the buffer layer; wherein
the buffer layer has a thickness of about 0.7 μm or more and about 6.1 μm or less; and
the antireflection layer has a thickness of about 0.07 μm or more and about 0.57 μm or less.

10: The lens according to claim 9, wherein
the buffer layer has a thickness of about 1.0 μm or more and about 5.0 μm or less; and
the antireflection layer has a thickness of about 0.10 μm or more and about 0.50 μm or less.

11: The lens according to claim 9, wherein the buffer layer has a thickness of about 1.6 μm or more.

12: The lens according to claim 9, wherein the buffer layer has a thickness of about 4.4 μm or less.

13: The lens according to claim 9, wherein
the buffer layer is made of resin including inorganic particles; and
the antireflection layer is made of an inorganic oxide.

14: A lens manufacturing method comprising:
a step a) of forming a buffer layer having a thickness of about 0.7 μm or more and about 6.1 μm or less on a convex surface of a lens body made of resin; and
a step b) of forming an antireflection layer having a thickness of about 0.07 μm or more and about 0.57 μm or less on the buffer layer.

15: The lens manufacturing method according to claim 14, wherein in the step a), the buffer layer is formed by applying, onto the convex surface, a buffer-layer-forming material that is a liquid containing inorganic particles and resin.

16: The lens manufacturing method according to claim 14, wherein in the step b), the antireflection layer is formed by vapor deposition.
